(19) United States
(12) Patent Application Publication
(10) Pub. No.: US 2023/0129933 A1
(43) Pub. Date: Apr. 27, 2023

(54) INCINERATOR FLY-ASH PELLETIZATION METHOD AND APPARATUS THEREOF

(71) Applicant: TAI YU TUNG TECHNOLOGY CO., LTD., New Taipei City (TW)

(72) Inventor: WEN-TUNG WEI, New Taipei City (TW)

(21) Appl. No.: 17/746,913

(22) Filed: May 17, 2022

(30) Foreign Application Priority Data
Oct. 22, 2021 (TW) 110139390

(51) Int. Cl. C04B 7/28; B28B 3/08

(52) U.S. Cl. CPC C04B 7/28; B28B 3/086; F23J 1/00

(57) ABSTRACT

Disclosed is an incinerator fly-ash pelletization method that concentratively arranges incinerated garbage fly ash inside a supporting member, and uses upper and lower molding members that are respectively provided with upper and lower pressing forces of different magnitudes to press and mold the incinerated garbage fly ash into a fly-ash pellet having a rounded projection portion on each of upper and lower surfaces thereof for reuse in a subsequent stage. The rounded projection portion functions to separate multiple fly-ash pellets that are stacked together to facilitate complete combustion, so as to effectively reduce environmental pollution and realize the purposes of recycling and reusing waste resources and improving economic values. The apparatus includes an apparatus chassis, and upper and lower hydraulic cylinders are arranged in the apparatus chassis to respectively connect to the upper and lower molding members that are each provided, at a central portion, with an arc-form shallow trough.

### TECHNICAL FIELD OF THE INVENTION

The present invention relates generally to an incinerator fly-ash pelletization method and an apparatus thereof, and more particularly to a pelletization method and an apparatus thereof, in which fly ash from incineration of garbage is pressed into fly-ash pellets for subsequent use in a later stage so as to prevent contamination to the environment.

### DESCRIPTION OF THE PRIOR ART

Municipal solid waste, after been incinerated, may produce remaining on an incineration hearth and a huge amount of waste gas is also generated during an incineration process. Such substances so generated or produced will be collected and captured by air pollution control facility and are commonly referred to as fly ashes. The municipal incineration fly ashes are considered hazardous industrial waste, and one primary way of handling that is contemporarily adopted is solidification treatment, followed by landfilling. For stabilization treatment of the incinerated garbage fly ash, cement solidification treatment is one common way adopted domestically, yet such a known way of cement solidification suffers the following shortcomings.

(1) Cement must be added by an amount of at least one third to achieve desired solidification, and consequently, the volume produced after solidification is large and an increased cost for handling is required.

(2) The incinerated garbage fly ash so treated with cement solidification becomes totally no value for reuses and can only be buried with soil.

(3) The incinerated garbage fly ash so solidified may still not be totally satisfactory in respect of stabilization, and consequently, after being buried with soil for an extended period of time, there is still a concern about heavy metal leaching, which causes contamination to the environment.

(4) The incinerated garbage fly ash so solidified suffers size bulkiness, and transportation and landfilling require a high human labor cost.

In view of such problems, the invention is made to provide an incinerator fly-ash pelletization apparatus that presses incinerated garbage fly ash into fly-ash pellets for reuse in a subsequent stage, so as to reduce a handling cost and prevent pollution to the environment.

### SUMMARY OF THE INVENTION

The primary objective of the present invention is to provide an incinerator fly-ash pelletization method and an apparatus thereof, which press incinerated garbage fly ash into fly-ash pellets for reuse in a subsequent stage, so as to realize purposes of recycling and reusing waste resources and improving economic values to thereby considerably reduce the cost for landfilling or handling waste.

The incinerator fly-ash pelletization method is implemented by concentratively arranging incinerated garbage fly ash from an incinerator between upper and lower molding members arranged in an apparatus chassis, and then using upper and lower molding members that are provided with pressing forces of different magnitudes to press and mold the incinerated garbage fly ash into a fly-ash pellet that has a rounded arc-form projection on each of upper and lower surfaces thereof for reuse in a subsequent stage, so as to effectively reduce environmental pollution and realize the purposes of recycling and reusing waste resources and improving economic values to thereby considerably reduce the cost for landfilling or handling waste.

The incinerator fly-ash pelletization apparatus comprises an apparatus chassis, and an upper molding member and a lower molding member arranged in the apparatus chassis to respectively connect to an upper hydraulic cylinder and a lower hydraulic cylinder. A feeding structure is arranged at one side of the apparatus chassis. Incinerated garbage fly ash of an incinerator is fed between the upper molding member and the lower molding member by the feeding structure, and the upper hydraulic cylinder and the lower hydraulic cylinder are operable to apply different pressing forces to respectively drive the upper molding member and the lower molding member, so as to press the incinerated garbage fly ash into a fly-ash pellet for reuse in a subsequent stage.

In the above incinerator fly-ash pelletization apparatus, the upper molding member and the lower molding member are each provided, at a central portion thereof, with an arc-form shallow trough having a proper depth, so that the incinerated garbage fly ash is pressed and molded into a fly-ash pellet having a rounded projection portion on a central part thereof, and in reuse in a subsequent stage, the rounded projection portions help separate multiple fly-ash pellets that are stacked together from each other to thereby facilitate complete combustion.

In the above incinerator fly-ash pelletization apparatus, the apparatus chassis comprises an upper positioning frame, and the upper hydraulic cylinder is arranged to extend through the upper positioning frame to connect to the upper molding member.

In the above incinerator fly-ash pelletization apparatus, the apparatus chassis comprises a lower positioning frame. A supporting member is arranged on the lower positioning frame. The lower molding member is disposed inside the supporting member. The lower hydraulic cylinder is arranged to extend through the lower positioning frame and the supporting member to connect to the lower molding member.

In the above incinerator fly-ash pelletization apparatus, the supporting member and the lower positioning frame are respectively formed with passages that correspond to and are in alignment with each other. A regulation valve is arranged at an outlet of the passages. A gap is formed between the lower molding member and an inner circumference of the supporting member to form, in combination with the passages and the regulation valve, a gas discharge structure for regulating the pressing forces.

### BRIEF DESCRIPTION OF THE DRAWINGS

FIG. 1 is a flow chart of pelletization according to the present invention.

FIG. 2 is a three-dimensional diagram of a pelletization apparatus according to the present invention.

FIG. 3 is a structure diagram of the pelletization apparatus according to the present invention.

FIG. 4 is a state diagram of feeding operation according to the present invention.

FIG. 5 is a state diagram of pressing operation according to the present invention.

FIG. 6 is a state diagram of shaping and demolding operation according to the present invention.

FIG. 7 is a perspective view showing a fly-ash pellet according to the present invention.

FIG. 8 is a plan view of the fly-ash pellet according to the present invention.

### DETAILED DESCRIPTION OF THE PREFERRED EMBODIMENT

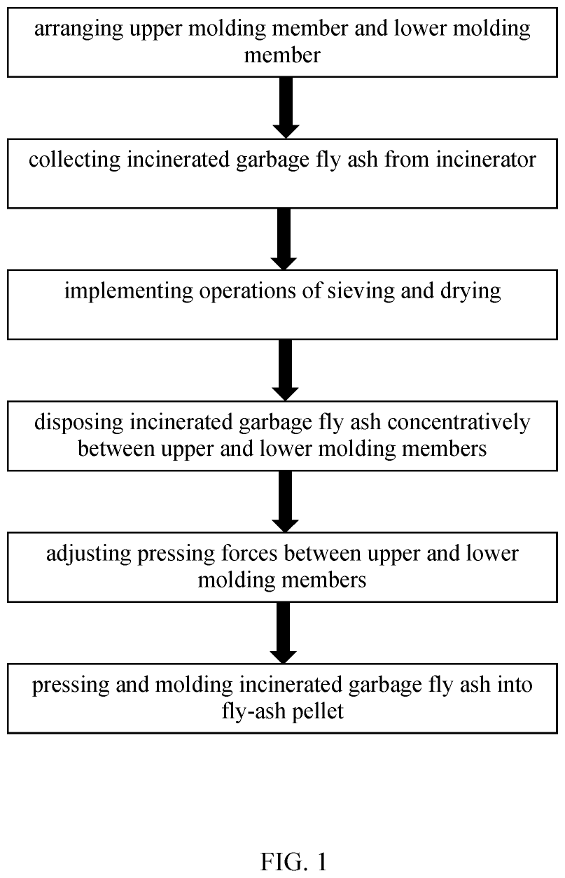

Referring to FIG. 1, which is a flow chart of pelletization according to the present invention, as shown in the drawing, a process of pelletization according to the present invention at least comprises the following steps:

(1) arranging an upper molding member and a lower molding member, which are each formed with an arc-form shallow trough in a central portion thereof, in an upper part and a lower part of an apparatus chassis, respectively;

(2) collecting incinerated garbage fly ash from an incinerator;

(3) subjecting the incinerated garbage fly ash collected from the incinerator to operations of sieving and drying;

(4) disposing the incinerated garbage fly ash of the incinerator concentratively between the upper and lower molding members arranged in the apparatus chassis;

(5) adjusting pressing forces supplied from the upper and lower molding members; and

(6) pressing and molding the incinerated garbage fly ash into a fly-ash pellet, which has a rounded projection portion on a central part of each of upper and lower surfaces thereof, by means of different magnitudes of the pressing forces, which are respectively around 300 tons supplied from the upper molding member and around 10 tons supplied from the lower molding member, for reuse in a subsequent stage, so as to effectively reduce environmental pollution and realize the purposes of recycling and reusing waste resources and improving economic values to thereby considerably reduce the cost for landfilling or handling waste, and also to facilitate complete combustion due to the rounded projection portions separating multiple stacked fly-ash pellets from each other.

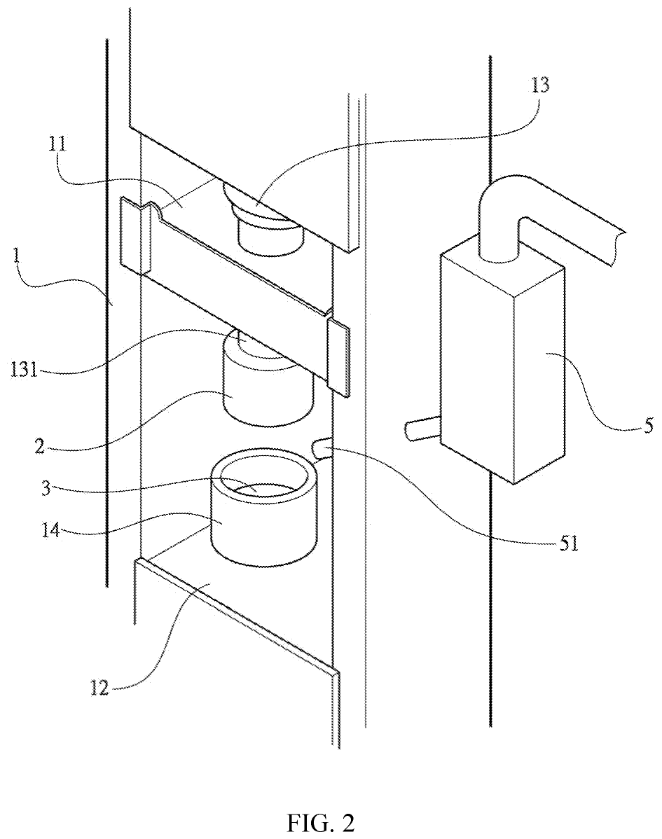

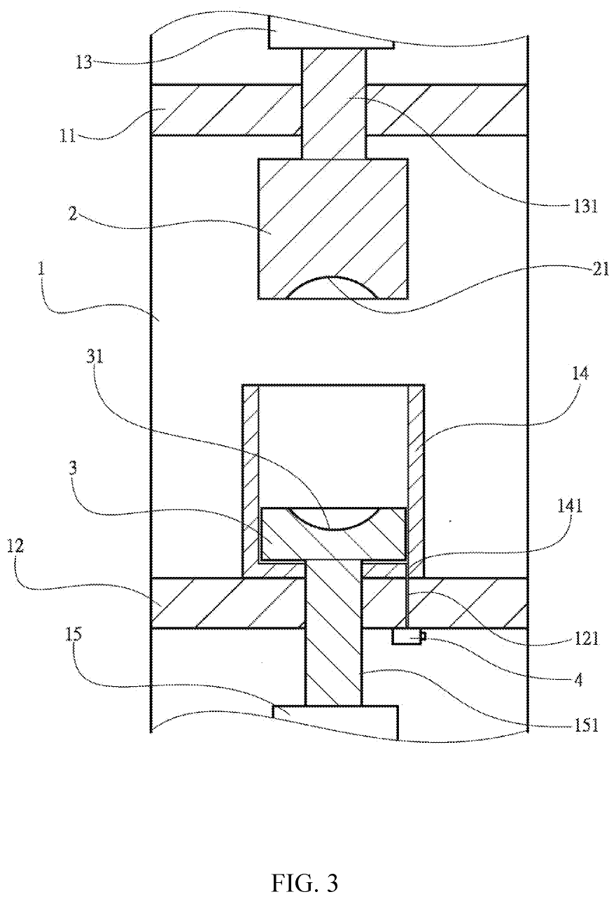

Referring to FIGS. 2 and 3, which are respectively three-dimensional diagram and a structure diagram of a pelletization apparatus according to the present invention, the present invention includes an apparatus chassis 1, and an upper positioning frame 11 and a lower positioning frame 12 are provided on the apparatus chassis 1, such that a proper spacing is formed between the upper positioning frame 11 and the lower positioning frame 12. An upper hydraulic cylinder 13 is arranged in an upper part of the apparatus chassis 1, and a driving rod 131 of the upper hydraulic cylinder 13 is arranged to extend through the upper positioning frame 11 to connect to an upper molding member 2 is formed, in a central portion thereof, with an arc-form shallow trough 21 having a proper depth. The upper hydraulic cylinder 13 is operable to drive the upper molding member 2 to move upwards/downwards. In the instant embodiment, the upper hydraulic cylinder 13 supplies a pressing force of 300 tons.

The lower positioning frame 12 is provided with a supporting member 14, and disposed in the supporting member 14 is a lower molding member 3 that is opposite to and corresponding to the upper molding member 2 and is formed, in a central portion thereof, with an arc-form shallow trough 31 having a proper depth. A lower hydraulic cylinder 15 is arranged below the positioning frame 12, such that a driving rod 151 of the lower hydraulic cylinder 15 extends through the lower positioning frame 12 and the supporting member 14 to connect to the lower molding member 3. The lower hydraulic cylinder 15 is operable to drive the lower molding member 3 to move upwards/downwards. In the instant embodiment, the lower hydraulic cylinder 15 supplies a pressing force of 10 tons.

The supporting member 14 and the lower positioning frame 12 are formed with passages 141, 121 that correspond to each other and are in alignment with each other. A regulation valve 4 is arranged at an outlet of the passage 121. A proper gag is arranged between the lower molding member 3 and an inner circumference of the supporting member 14, so as to form, in combination with the passages 141, 121 and the regulation valve 4, a gas discharge structure that functions for regulation of pressing force.

At one side of the apparatus chassis 1, a feeding structure 5 is arranged so that a feeding pipe 51 of the feeding structure 5 extends to reach a location above the supporting member 14.

With a combination of the above-described components/parts, an incinerator fly-ash pelletization apparatus is formed. Incinerated garbage fly ash from an incinerator is fed through the feeding pipe 51 of the feeding structure 5 into the lower molding member 3 disposed inside the supporting member 14, and the upper hydraulic cylinder 13 and the lower hydraulic cylinder 15 are operable to provide different pressing forces to respectively drive the upper molding member 2 and the lower molding member 3 for pressing and molding the fly ash into a fly-ash pellet that includes rounded projection portions on a central part thereof.

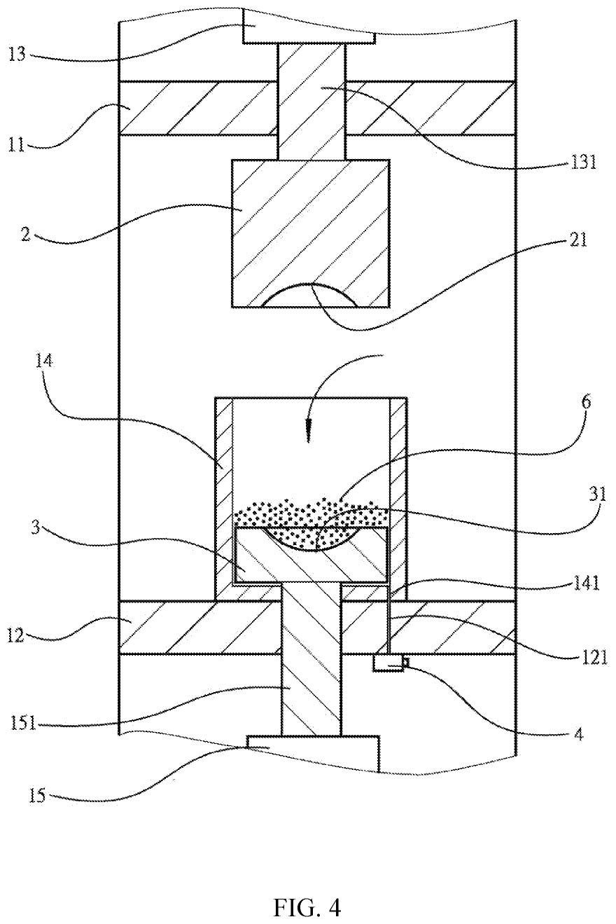

Referring to FIG. 4, which a state diagram of feeding operation according to the present invention, as shown in the drawing, to operate the present invention, the upper molding member 2 is moved upward and the lower molding member 3 is moved downward to a lowest position in the supporting member 14. Incinerated garbage fly ash 6 supplied from an incinerator is fed through the feeding pipe 51 of the feeding structure 5 into the lower molding member 3 disposed inside the supporting member 14, and the fly ash, after having been fed for a predetermined amount, is automatically stopped feeding to be subsequently pressed and molded.

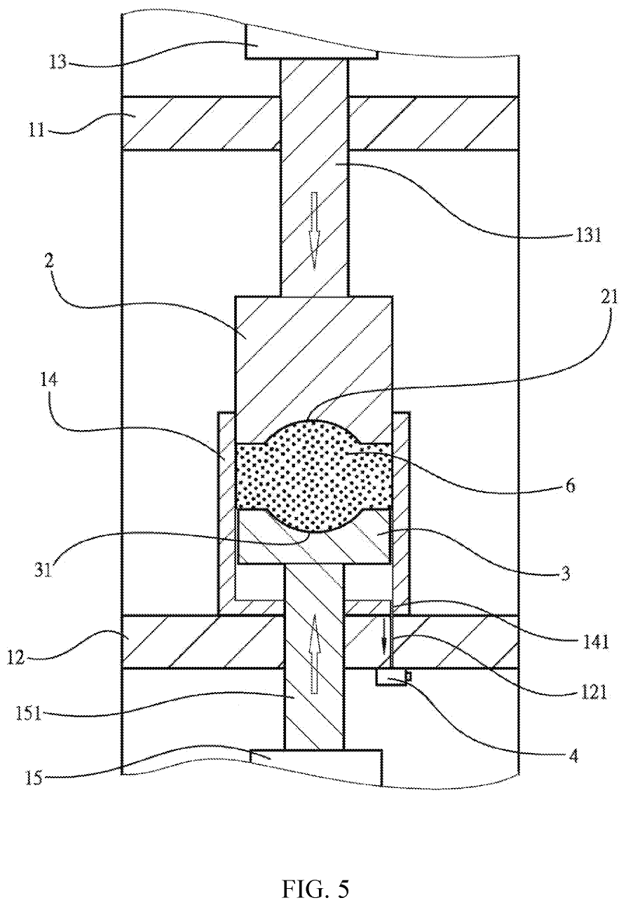

Referring to FIG. 5, which is a state diagram of pressing operation according to the present invention, as shown in the drawing, after the feeding structure 5 finishes feeding of the incinerated garbage fly ash 6 of the incinerator into the lower molding member 3 disposed inside the supporting member 14, the present invention proceeds to separately activating the upper hydraulic cylinder 13 and the lower hydraulic cylinder 15 so as to apply different pressing forces to drive the upper molding member 2 and the lower molding member 3 to press and compress the incinerated garbage fly ash 6 to thereby press the incinerated garbage fly ash 6 into a fly-ash pellet 7, wherein since the upper hydraulic cylinder 13 provides a pressing force of around 300 tons, while the lower hydraulic cylinder 15 provides a pressing force of around 10 tons, the lower molding member 3 gets vibrating due to the relatively small pressing force and consequently, the incinerated garbage fly ash 6 becomes better homogenized. Since the upper molding member 2 and the lower molding member 3 are respectively provided, on the central portions thereof, with the arc-form shallow troughs 21, 31, the pressing force is caused to get more concentrated to apply at the central portions, while not applying toward the outside thereby facilitating shaping of the fly-ash pellet 7.

During the pressing operation described above, since there is air existing in the incinerated garbage fly ash 6, the gap formed between the lower molding member 3 and the inner circumference of the supporting member 14 and also the aligned passages 141, 121 of the supporting member 14 and the positioning frame 12 allow the air released during pressing to discharge to the outside, and a discharge amount thereof is adjusted and regulated by the regulation valve 4 to thereby properly adjust the pressure from the pressing forces of the upper molding member 2 and the lower molding member 3 to make the fly-ash pellet 7 so molded and shape more solid and more concrete.

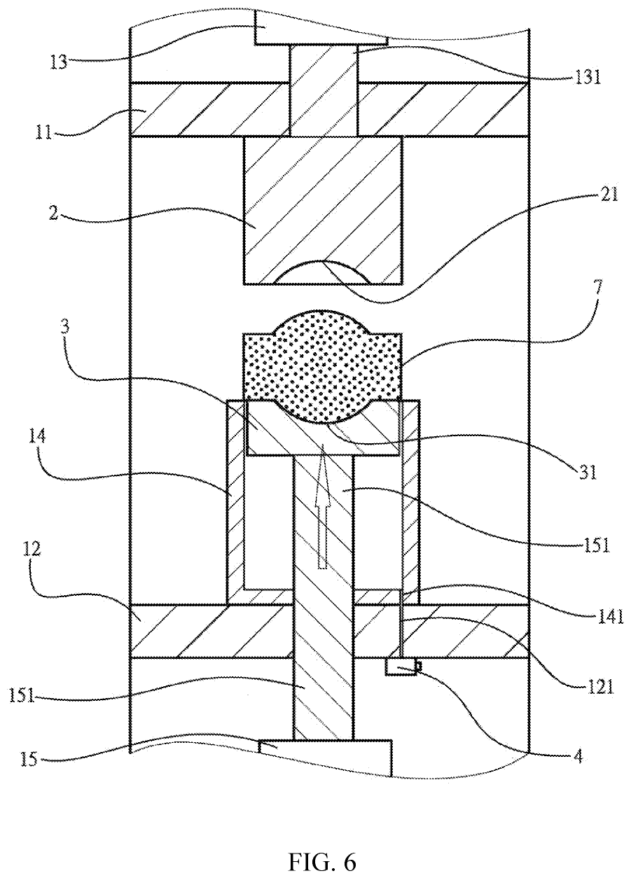

Referring to FIG. 6, which is a state diagram of shaping and demolding operation according to the present invention, as shown in the drawing, after the pressing operation is completed, the present invention further proceeds to have the upper hydraulic cylinder 13 driving the upper molding member 2 to move upward to a top point and the lower hydraulic cylinder 15 driving the lower molding member 3 to move upward to lift the fly-ash pellet 7 upward to expose outside the supporting member 14, so that the fly-ash pellet 7 can be removed to complete demolding.

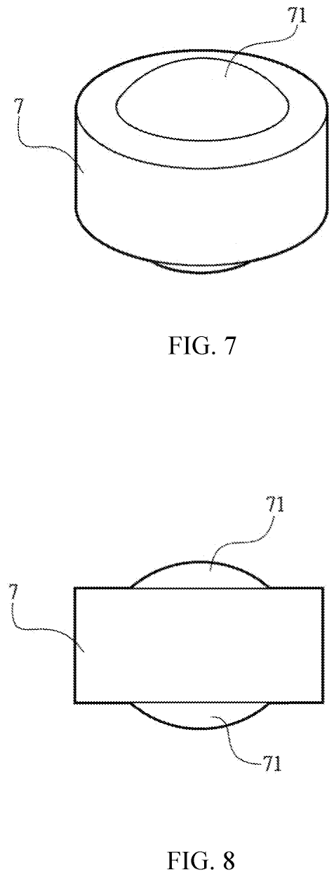

Referring to FIGS. 7 and 8, which are respectively a perspective view and a plan view of the fly-ash pellet according to the present invention, as shown in the drawings, a final product of the fly-ash pellet 7 according to the present invention includes the rounded projection portions 71 on the central portion thereof for subsequent reuse in a later stage (such as serving as a comburent material for combustion facilities). Further, the rounded projection portion 71 helps separate multiple fly-ash pellets 7 that are stacked together and would thus be helpful for complete combustion, so that pollution to the environment can be effectively reduced, and purposes of recycling and reusing waste resources and improving economic values can be realized to thereby considerably reduce the cost for landfilling or handling waste.

Compared to the known way of handling incinerated garbage fly ash by means of cement solidification, the present invention provides, at least, the following advantages:

(1) Compared to cement solidification, the fly-ash pellet made according to the present invention may greatly reduce the volume thereof, for being reduced to at least around 22%, to reduce the space for storage and also to facilitate transportation thereof.

(2) Compared to cement solidification, the fly-ash pellet made according to the present invention requires a handling cost and human labor cost that are greatly lowered down.

(3) Compared to cement solidification that requires landfilling, the fly-ash pellet made according to the present invention avoids secondary contamination to the environment.

(4) Compared to cement solidification, the fly-ash pellet made according to the present invention has a reduced amount of powder dust due to pelletization so as to avoid contamination to the environment.

(5) Compared to cement solidification that necessarily requires landfilling, the fly-ash pellet made according to the present invention is reusable in a subsequent stage so as to realize recycling and reusing waste resources to thereby improve economic values.

In summary, the present invention uses the apparatus chassis that is provided with the upper and lower hydraulic cylinders to operate in combination with the molding members that are mounted to the upper and lower hydraulic cylinders and are formed with shallow troughs to implement the incinerator fly-ash pelletization method and the apparatus thereof, in which incinerated garbage fly ash is pressed and molded into a fly-ash pellet for reuse in a subsequent stage so as to effectively reduce environmental pollution and realize the purposes of recycling and reusing waste resources and improving economic values to thereby considerably reduce the cost for landfilling or handling waste.

I claim:

1. An incinerator fly-ash pelletization method, comprising:
arranging an upper molding member and a lower molding member in an upper part and a lower part of an apparatus chassis, respectively;
subjecting incinerated garbage fly ash collected from an incinerator to operations of sieving and drying;
disposing an amount of the incinerated garbage fly ash from the incinerator concentratively between the upper molding member and the lower molding member arranged in the apparatus chassis;
adjusting pressing forces supplied from the upper molding member and the lower molding member; and
pressing and molding the incinerated garbage fly ash into a fly-ash pellet by means of different magnitudes of the pressing forces, which are respectively around 300 tons supplied from the upper molding member and around 10 tons supplied from the lower molding member.

2. An incinerator fly-ash pelletization apparatus, comprising an apparatus chassis, wherein an upper molding member is arranged in an upper part of the apparatus chassis and is connected to a driving rod of an upper hydraulic cylinder; a supporting member is arranged in a lower part of the apparatus chassis and a lower molding member is disposed inside the supporting member and connected to a driving rod of a lower hydraulic cylinder; a feeding structure is arranged at one side of the apparatus chassis, wherein the upper molding member and the lower molding member are each formed, in a central portion thereof, with an arc-form shallow trough; incinerated garbage fly ash from an incinerator is fed by the feeding structure into the supporting member, and the upper hydraulic cylinder and the lower hydraulic cylinder are operable to apply different pressing forces to respectively drive the upper molding member and the lower molding member, so as to press the incinerated garbage fly-ash into a fly-ash pellet having a rounded projection portion formed at a central part thereof.

3. The incinerator fly-ash pelletization apparatus according to claim 2, wherein the apparatus chassis comprises an upper positioning frame, and the driving rod of the upper hydraulic cylinder extends through the upper positioning frame to connect to the upper molding member.

4. The incinerator fly-ash pelletization apparatus according to claim 2, wherein the apparatus chassis comprises a lower positioning frame, and the supporting member is arranged on the lower positioning frame, the driving rod of the lower hydraulic cylinder extending through the lower positioning frame and the supporting member to connect to the lower molding member.

5. The incinerator fly-ash pelletization apparatus according to claim 2, wherein the supporting member and the lower positioning frame are respectively formed with passages that correspond to and are in alignment with each other, and a regulation valve is arranged at an outlet of the passages; and a gap is formed between the lower molding member and an inner circumference of the supporting member, so as to form, in combination with the passages and the regulation valve, a gas discharge structure for regulation of the pressing force.
